(19) United States
(12) Patent Application Publication
(10) Pub. No.: US 2008/0151894 A1
(43) Pub. Date: Jun. 26, 2008

(54) Selectively hybrid input and output queued router

(75) Inventors: Subramaniam Maiyuran, Gold River, CA (US); Aaron Spink, San Francisco, CA (US); Nitin Agrawal, Bangalore (IN)

Correspondence Address: INTEL/BLAKELY, 1279 OAKMEAD PARKWAY, SUNNYVALE, CA, 94085-4040, US

(73) Assignee: Intel Corporation

(21) Appl. No.: 11/644,711

(22) Filed: Dec. 22, 2006

(51) Int. Cl. H04L 12/56

(52) U.S. Cl. 370/392; 370/412

(57) ABSTRACT

An apparatus is described that routes packets to, from, and within a socket. The apparatus includes routing components that provide different functionality based upon which socket component they are connected to. One routing component is connected to an interface that communicates with the processor core of the socket.

### FIELD OF INVENTION

The field of invention relates to the computer sciences, generally, and, more specifically, to router circuitry for a link based computing system.

### BACKGROUND

Computing systems have traditionally been designed with a “front-side bus” between their processors and memory controller(s). High end computing systems typically include more than one processor so as to effectively increase the processing power of the computing system as a whole. Unfortunately, in computing systems where a single front-side bus connects multiple processors and a memory controller together, if two components that are connected to the bus transfer data/instructions between one another, then, all the other components that are connected to the bus must be “quiet” so as to not interfere with the transfer.

For instance, if four processors and a memory controller are connected to the same front-side bus, and, if a first processor transfers data or instructions to a second processor on the bus, then, the other two processors and the memory controller are forbidden from engaging in any kind of transfer on the bus. Bus structures also tend to have high capacitive loading which limits the maximum speed at which such transfers can be made. For these reasons, a front-side bus tends to act as a bottleneck within various computing systems and in multi-processor computing systems in particular.

In recent years computing system designers have begun to embrace the notion of replacing the front-side bus with a network or router. One approach is to replace the front-side bus with a router having point-to-point links (or interconnects) between each one of processors through the network and memory controller(s). The presence of the router permits simultaneous data/instruction exchanges between different pairs of communicating components that are coupled to the network. For example, a first processor and memory controller could be involved in a data/instruction transfer during the same time period in which a second and third processor are involved in a data/instruction transfer.

Memory latency becomes a problem when connecting several components in a single silicon implementation via a router with many ports. This large router latency contributes to higher memory latency, especially on cache snoop requests and responses. In the number of ports in the router is small, point-to-point links are readily achievable. However, if the number of ports is large (for example, more than eight ports), routing congestion, porting, and buffering requirements become prohibitive, especially if the router is configured as a crossbar.

### BRIEF DESCRIPTION OF THE DRAWINGS

The present invention is illustrated by way of example and not limitation in the figures of the accompanying drawings, in which like references indicate similar elements and in which:

FIG. 1 shows a detailed depiction of a multi-processor computing system that embraces the placement of a network between components within the computing system;

FIG. 2 illustrates an embodiment of a multiprocessor system according to an embodiment;

FIG. 3(a) illustrates an exemplary embodiment of a configuration of routing components in a socket;

FIG. 3(b) illustrates an embodiment of a routing component not connected to a core interface;

FIG. 3(c) illustrates an embodiment of a routing component connected to the core interface;

FIG. 4 illustrates an exemplary flow for transaction processing using a non-core interfaced routing component;

FIG. 5 illustrates an exemplary flow for transaction processing using a core interfaced routing component;

FIG. 6 illustrates a front-side-bus (FSB) computer system in which one embodiment of the invention may be used; and

FIG. 7 illustrates a computer system that is arranged in a point-to-point (PtP) configuration.

### DETAILED DESCRIPTION

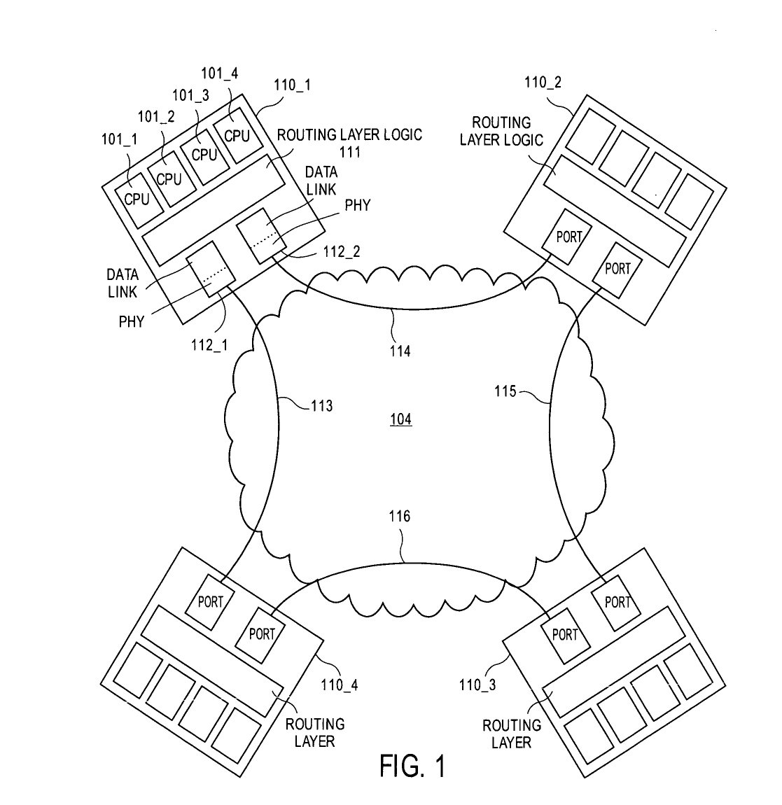

FIG. 1 shows a detailed depiction of a multi-processor computing system that embraces the placement of a network, rather than a bus, between components within the computing system. The components 110_1 through 110_4 that are coupled to the network 104 are referred to as “sockets” because they can be viewed as being plugged into the computing system's network 104. One of these sockets, socket 110_1, is depicted in detail.

According to the depiction observed in FIG. 1, socket 110_1 is coupled to network 104 through two bi-directional point-to-point links 113, 114. In an implementation, each bi-directional point-to-point link is made from a pair of uni-directional point-to-point links that transmit information in opposite directions. For instance, bi-directional point-to-point link 114 is made of a first uni-directional point-to-point link (e.g., a copper transmission line) whose direction of information flow is from socket 110_1 to socket 110_2 and a second uni-directional point-to-point link whose direction of information flow is from socket 110_2 to socket 110_1.

Because two bi-directional links 113, 214 are coupled to socket 110_1, socket 110_1 includes two separate regions of data link layer and physical layer circuitry 112_1, 112_2. That is, circuitry region 112_1 corresponds to a region of data link layer and physical layer circuitry that services bi-directional link 113; and, circuitry region 112_2 corresponds to a region of data link layer and physical layer circuitry that services bi-directional link 114. As is understood in the art, the physical layer of a network typically forms parallel-to-serial conversion, encoding and transmission functions in the outbound direction and, reception, decoding and serial-to-parallel conversion in the inbound direction.

That data link layer of a network is typically used to ensure the integrity of information being transmitted between points over a point-to-point link (e.g., with CRC code generation on the transmit side and CRC code checking on the receive side). Data link layer circuitry typically includes logic circuitry while physical layer circuitry may include a mixture of digital and mixed-signal (and/or analog) circuitry. Note that the combination of data-link layer and physical layer circuitry may be referred to as a “port” or Media Access Control (MAC) layer. Thus circuitry region 112_1 may be referred to as a first port or MAC layer region and circuitry region 112_2 may be referred to as a second port or MAC layer circuitry region.

Socket 110_1 also includes a region of routing layer circuitry 111. The routing layer of a network is typically responsible for forwarding an inbound packet toward its proper destination amongst a plurality of possible direction choices. For example, if socket 110_2 transmits a packet along link 114 that is destined for socket 110_4, the routing layer 111 of socket 110_1 will receive the packet from port 112_2 and determine that the packet should be forwarded to port 112_1 as an outbound packet (so that it can be transmitted to socket 110_4 along link 113).

By, contrast, if socket 110_2 transmits a packet along link 114 that is destined for processor (or processing core) 101_1 within socket 110_1, the routing layer 111 of socket 110_1 will receive the packet from port 112_2 and determine that the packet should be forwarded to processor (or processing core) 101_1. Typically, the routing layer undertakes some analysis of header information within an inbound packet (e.g., destination node ID, connection ID) to “look up” which direction the packet should be forwarded. Routing layer circuitry 111 is typically implemented with logic circuitry and memory circuitry (the memory circuitry being used to implement a “look up table”).

The particular socket 110_1 depicted in detail in FIG. 1 contains four processors (or processing core) 101_1 through 101_4. Here, the term processor, processing core and the like may be construed to mean logic circuitry designed to execute program code instructions. Each processor may be integrated on the same semiconductor chip with other processor(s) and/or other circuitry regions (e.g., the routing layer circuitry region and/or one or more port circuitry region). It should be understood that more than two ports/bi-directional links may be instantiated per socket. Also, the computing system components within a socket that are “serviced by” the socket's underlying routing and MAC layer(s) may include a component other than a processor such as a memory controller or I/O hub.

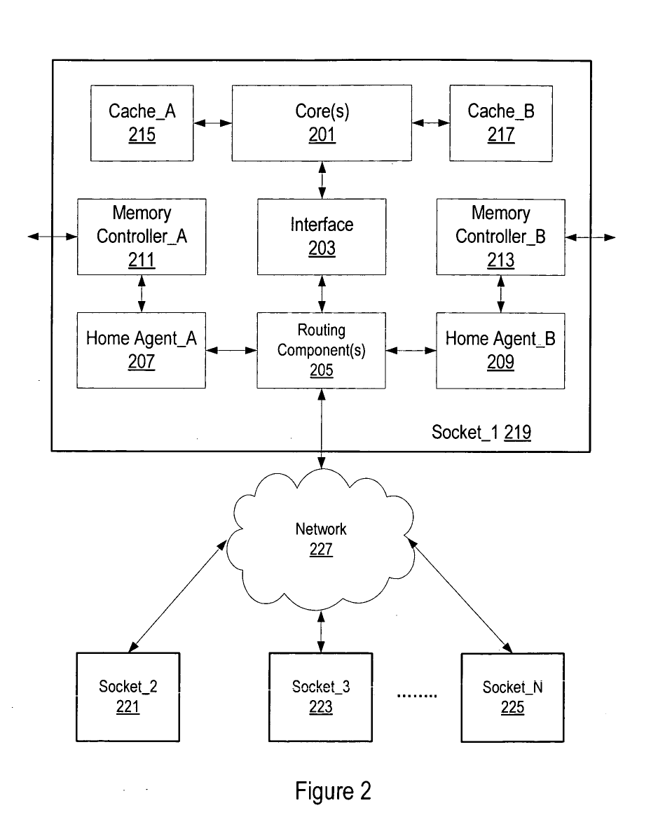

FIG. 2 illustrates an embodiment of a multiprocessor system according to an embodiment. A plurality of sockets (or processors) 219, 221, 223, 225 communicate with one another through the use of a network 227. The network 227 may be a crossbar, a collection of point-to-point links as described earlier, or other network type.

Socket_1 219 is shown in greater detail and includes at least one processing core 201 and cache 217, 215 associated with the core(s) 201. Routing components 205 connect the socket 219 to the network 227 and provide a communication path between socket 219 and the other sockets connected to the network 227. The routing components 205 may include the data link circuitry, physical layer circuitry, and routing layer circuitry described earlier.

A core interface 203 translates requests from the core(s) 201 into the proper format for the routing components 205 and vice versa. For example, the core interface 203 may packetize data from the core for the routing component(s) 205 to transmit across the network. Of course, the core interface 203 may also depacketize transactions that come from the routing component(s) 205 so that the core(s) are able to understand the transactions.

At least a portion of the routing component(s) 205 communicate with home agents 207, 209. A home agent 207, 209 manages the cache coherency protocol utilized in a socket and accesses to the memory (using the memory controllers 211, 213 for some process requests). In one embodiment, the home agents 207, 209 include a table for holding pending cache snoops in the system. The home agent table contains the cache snoops that are pending in the system at the present time. The table holds at most one snoop for each socket 221, 223, 225 that sent a request (source caching agent). In an embodiment, the table is a group of registers wherein each register contains one request. The table may be of any size, such as 16 or 32 registers.

Home agents 207, 209 also include a queue for holding requests or snoops that cannot be processed or sent at the present time. The queue allows for out-of-order processing of requests sequentially received. In an example embodiment, the queue is a buffer, such as a First-In-First-Out (FIFO) buffer.

The home agents 207, 209 also include a directory of the information stored in all caches of the system. The directory need not be all-inclusive (e.g., the directory does not need to contain a list of exactly where every cached line is located in the system). Since a home agent 207, 209 services cache requests, the home agent 207, 209 must know where to direct snoops. In order for the home agent 207, 209 to direct snoops, it should have some ability to determine where requested information is stored. The directory is the component that helps the home agent 207, 209 determine where information in the cache of the system is stored. Home agents 207, 209 also receive update information from the other agents through the requests it receives and the responses it receives from source and destination agents or from a “master” home agent (not shown).

Home agents 207, 209 are a part of, or communicate with, the memory controllers 211, 213. These memory controllers 211, 213 are used to write and/or read data to/from memory devices such as Random Access Memory (RAM).

Of course, the number of caches, cores, home agents, and memory controllers may be more or less than what is shown in FIG. 2.

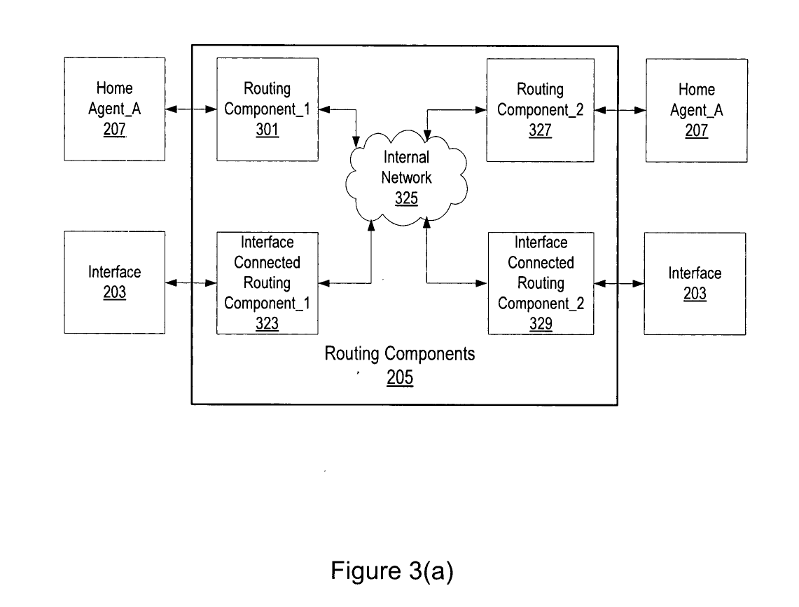

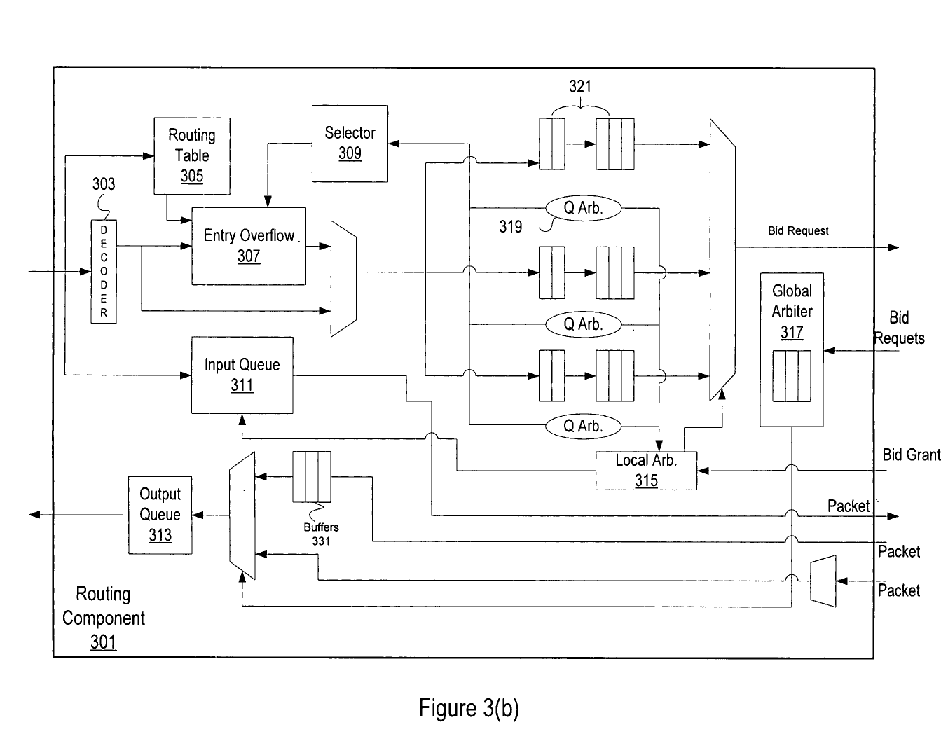

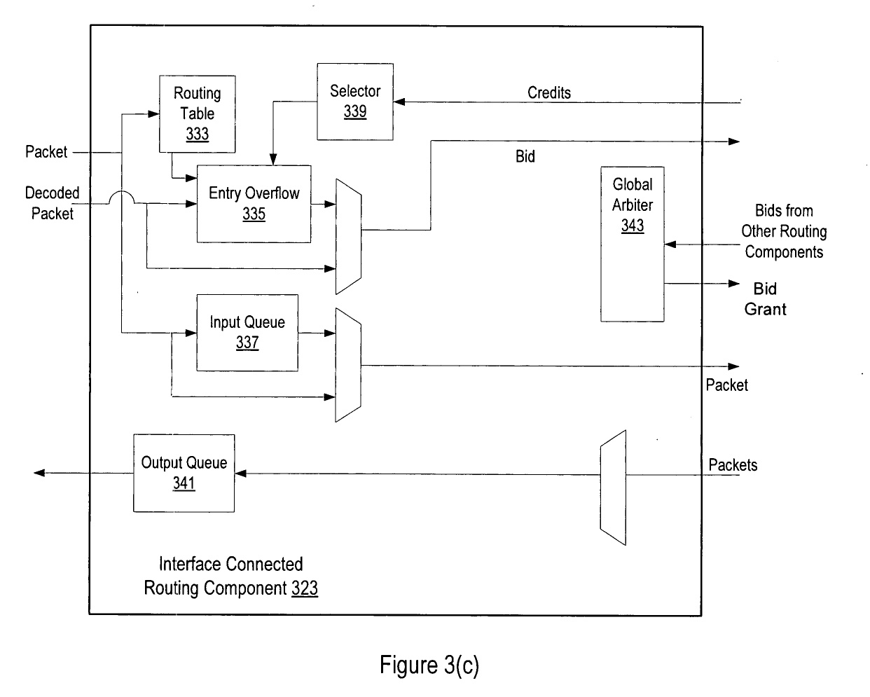

FIG. 3(a) illustrates an exemplary embodiment of a configuration of routing components in a socket. In this example, four routing components 205 are utilized in the socket. Typically, there is one routing component per core interface, home agent, etc. However, more than one routing component may be assigned to these internal socket components. In prior art systems, routing components were not specifically dedicated to the core interface or home agents.

These routing components pass requests and responses to each other via an internal network 325. This internal network 325 may consist of a crossbar or a plurality of point-to-point links.

Routing component_1 301 handles communications that involve home agent_A 207. For example, this routing component 301 receives and responds to requests from the other routing components 323, 327, 329 and forwards these requests to home agent_A 207 and forwards responses back from the home agent_A 207. Routing component_2 327 works in a similar manner with home agent_B 209.

Core interface connected routing component_1 323 handles communications that involve the interface 203. Core interface connected routing components receive and respond to requests from other routing components, and forward these requests to the core interface and also process the responses. As described earlier, these requests from the other routing components are typically packetized and the core interface 203 de-packetizes the requests and forwards them to the core(s) 201. Interface connected routing component_2 329 works in a similar manner. In one embodiment, cache snoop and response requests are routed through the interface connected routing components 323, 329. This routing leads to increased performance for cache snoops with responses by reducing latency.

Additionally, routing components 205 may communicate to other sockets. For example, each routing component or the group of routing components may be connected to ports which interface with other sockets in a point-to-point manner.

FIG. 3(b) illustrates an embodiment of a routing component not connected to a core interface. This routing component interacts with internal socket components that are not directly connected to the core interface 203. The routing component 301 includes: a decoder 303, a routing table 305, entry overflow buffer 307, a selection mechanism 309, an input queue 311, output queue 313, and arbitration mechanisms 319, 315, 317.

The decoder 303 decodes packets from other components of the socket. For example, if the routing component is connected to a home agent, then the decoder 303 decodes packets from that home agent.

The routing table 305 contains routing information such as addresses for other sockets and intra-socket components. The entry overflow buffer 307 stores information such as the data from a packet that is to be sent out, additional routing information not found in the routing table 305 (more detailed information such as the routing component in a socket that the packet is to be addressed), and bid request information. A bid is used by a routing component to request permission to transmit a packet to another routing compact. A bid may include the amount of credit available to the sender, the size of the packet, the priority of the packet, etc.

The input queue 311 holds an entire packet (such as a request or response to a request) that is to be sent to another routing component (and possibly further sent to outside of the socket). The packet includes a header with routing information and data.

The exemplary routing component 301 includes several levels of arbitration that are used during the processing of requests to other routing components and responses from these routing components. The first level of arbitration (queue arbitration) deals with the message type and which other component is to receive the message. Sets of queues 321 for each other component receive bid requests from the entry overflow buffer 307 and queue the requests. The entry overflow buffer 307 may also be bypassed and bids directly stored in a queue from the set. For example, the entry overflow buffer 307 may be bypassed if an appropriate queuce has open slots.

A queue arbiter 319 determines which of the bids in the queue will participate in the next arbitration level. This determination is performed based on a “fairness” scheme. For example, the selection of a bid from a queue may be based on a least recently used (LRU), oldest valid entry, etc. in the queue and the availability of the target routing component. Typically, there is a queue arbiter 319 for each set of queues 321 and each queue arbiter 319 performs an arbitration for its set of queues. With respect to the example illustrated, three (3) bids will be selected during queue arbitration.

The bids selected in the first level of arbitration participate in the second level of arbitration (local arbitration). Generally, in this level, the bid from least recently used queue is selected by the local arbiter 315 as the bid request that will be sent out to the other routing component(s). After this selection has been made, or concurrent to the selection, the selector 309 selects the next bid from the entry overflow 307 to occupy the space in the queue now vacated by the bid that won the local arbitration.

The winning bid that is sent from the routing component to a different routing component in the second level of arbitration is then put through a third stage of arbitration (global arbitration). The arbitration occurs in the receiving component. At this level, the global arbiter 317 of the routing component receiving the bid (not shown in this figure), determines if the bid will be granted. A granted bid means that the receiving component is able to process the packet that is associated with the bid. Global arbiters 317 look at one or more of the following to determine if a bid has been accepted: 1) the sender's available credit (does the sender have the bandwidth to send out the packet); 2) the receiving component's buffer availability (can it handle the packet); and/or 3) the priority of the incoming packet.

Once a bid has been selected, the global arbiter will send a bid granted notification to the routing component that submitted the “winning” bid. This notification is received by the local arbiter 315 which then informs the input queue 311 to transmit the packet associated with the bid to the receiving component.

Of course, additional or fewer levels of arbitration may be utilized. For example, the first level of arbitration is skipped in embodiments when there are not separate queues for each receiving routing component.

The routing component 301 receives two different kinds of packets from the other routing components: 1) packets from core interface connected routing components and 2) packets from other routing components that are not connected to the core interface. Packets from the core interface connected routing components (such as 323, 329) are buffered at buffers 331. This is because these packets may arrive at any time without the need for bid requests to be sent. Typically, these packets are sent if the routing component 301 has room for it (has enough credits/open buffer space). Packets sent from the other non-core interfaced routing components (such as 327) are sent in response to the global arbiter of the receiving routing component picking a winner in the third level of arbitration for a bid submitted to it.

The global arbiter 317 determines which of these two types of packet will be sent through the output queue 313 to either intra-socket components or other sockets. Packets are typically sent over point-to-point links. In one embodiment, the output queue 313 cannot send packets to the core interface 203.

FIG. 3(c) illustrates an embodiment of a routing component connected to the core interface. This routing component 323 is responsible for interacting with the core interface 203. The interface connected routing component 323 includes: a routing table 333, entry overflow buffer 335, a selection mechanism 339, an input queue 337, output queue 341, and arbitration mechanism 343. In one embodiment, snoop requests and responses are directed toward this component 323.

The routing table 333 contains routing information such as addresses for other sockets and routing components. The routing table 333 receives a complete packet from the core interface.

The entry overflow buffer 335 stores information such as the data from a packet that is to be sent out, additional routing information not found in the routing table 333 (more detailed information such as the routing component in a socket that the packet is to be addressed), and bid information is stored. As shown, a decoded packet is sent to the entry overflow buffer 335 by the core interface. One or more clock cycles are saved by having the core interface pre-decode or not encode the packet prior to sending it to the core interface connected routing component 323. Of course, a decoder may be added to the interface connected routing component 323 to add decode functionality if the core interface is unable decode a packet prior to sending it.

The input queue 337 holds an entire packet from the core interface (such as a request or response to a request) that is to be sent to another routing component (and possibly further sent to outside of the socket). The packet includes a header with routing information and data.

The exemplary interface connected routing component 323 has two arbitration stages and therefore has simpler processing of transactions to and from the core(s) than the other routing components have for their respective socket components. In the first arbitration stage, credits from the other routing components are received by a selector 339. These credits indicate if the other routing components have available space in their buffers 331. The selector 339 then chooses the appropriate bid to be sent from the entry overflow 335. This bid is received by the other routing components' global arbiter 317.

The second arbitration stage is performed by the global arbiter 343 which receives bids from the other routing components and determines which bid will be granted. A granted bid means that the core interface connected routing component 323 is able to process the packet that is associated with the bid. The global arbiter 343 looks at one or more of the following to determine if a bid has been accepted: 1) the sender's available credit (does the sender have the bandwidth to send out the packet); 2) the receiving component's buffer availability (can it handle the packet); and/or 3) the priority of the incoming packet.

Once a bid has been selected, the global arbiter 343 will send a bid granted notification to the routing component that submitted the “winning” bid. This notification is received by the requestor's local arbiter 315 which then informs its input queue 311 to transmit the packet associated with the bid to the receiving component.

The core interface connected routing component 323 receives packets from the non-core interface connected routing components in response to granted bids. These packets may then be forwarded to the core interface, any other socket component, or to another socket, through the output queue. Packets are typically sent over point-to-point links.

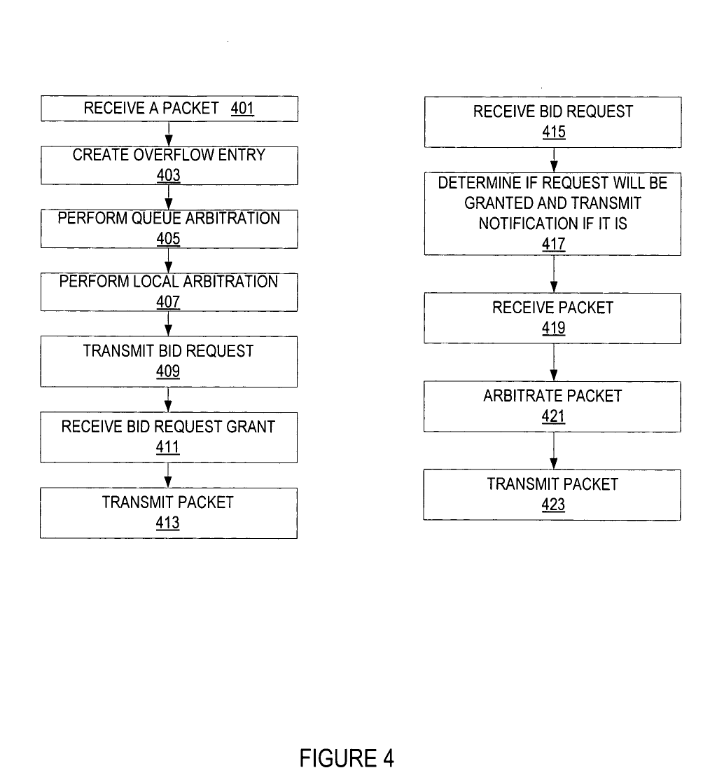

FIG. 4 illustrates an exemplary flow for transaction processing using a non-core interfaced routing component such as routing component_1 301 and routing component_2 327. A packet from a socket component in communication with the routing component is received at 401. For example, routing component_1 301 receives packets from home agent_A 207.

The received packet is decoded and an entry in the overflow buffer of the routing component is created at 403. Additionally, the received packet is stored in the input queue.

The entry from the overflow buffer participates in queue arbitration at 405. As described before, this arbitration is performed based on “fairness” scheme. For example, the selection of a bid may be based on a least recently used (LRU), oldest valid entry, etc. in the queue and the availability of the target component.

The winner from each queue's arbitration goes through local arbitration at 407. For example, the winner from each the three queues of FIG. 3(b) goes through local arbitration. Local arbitration picks one of the winners from queue arbitration to send a bid request to another or all other routing components. The bid request is sent from the entry overflow at 409.

The routing component receives a bid grant notification from another routing component at 411. The local or global arbiter of the routing component receives this bid grant notification.

The local or global arbiter then signals the input queue of the routing component to transmit the packet associated with the bid request and bid grant notification. This packet is transmitted at 413 to the appropriate routing component.

A non-core interfaced routing component also processes bid requests from other components including core-interfaced routing components. A bid request is received at 415. As described earlier, bid requests are received by global arbiters.

The global arbiter arbitrates which bid request will be granted and a grant notification is sent to the winning routing component at 417. In an embodiment, no notifications will be sent to the losing requests. The routing component will then receive a packet from the winner component at 419 in response to the grant notification. This packet is arbitrated against other packets (for example, packets stored in the buffer that holds packets from the core interface connected routing component(s)) at 421. The packet that wins this arbitration is transmitted at 423 to its proper destination (after a determination of where the packet should go).

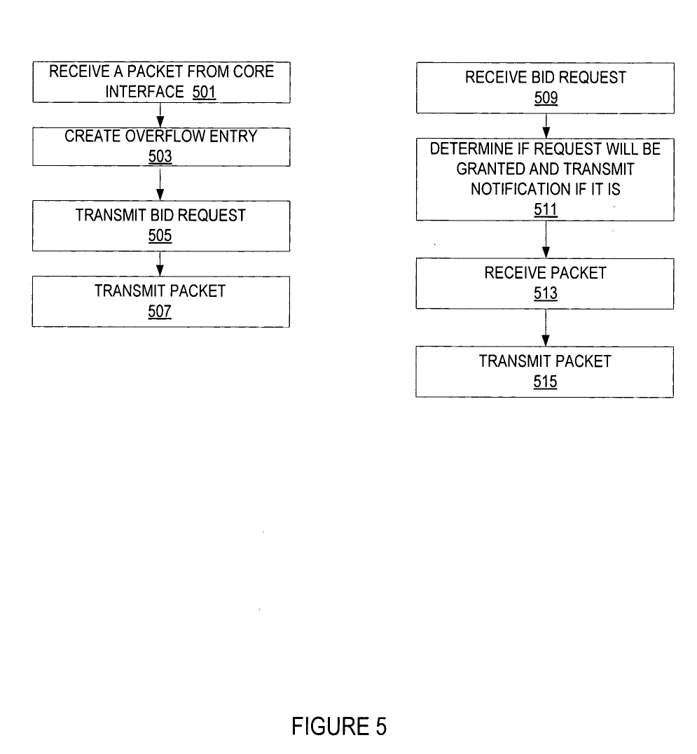

FIG. 5 illustrates an exemplary flow for transaction processing using a core interfaced routing component such as interface connected routing component_1 323 and interface connected routing component_2 329. A packet from the core interface is received at 501. For example, interface connected routing component_1 323 receives packets from interface 203.

The received packet is decoded (if necessary) and an entry in the overflow buffer of the routing component is created at 503. Additionally, the received packet is stored in the input queue.

A bid from the entry overflow buffer is selected and transmitted at 505. This selection is based, at least in part, on the available credits/buffer space of the other routing components.

The packet associated with that bid is transmitted at 507. Again, the transmission is based on the credit available at the other routing components.

A core interfaced routing component also processes bid requests from other components. A bid request is received at 509. As described earlier, bid requests are received by the global arbiter.

The global arbiter arbitrates which bid request will be granted and a grant notification is sent to the winning routing component at 511. In an embodiment, no notifications will be sent to the losing requests. The interface connected routing component will then receive a packet from the winner component at 513 in response to the grant notification. A determination of who should receive this packet is made and the packet is transmitted to either the core interface or another socket at 515.

Embodiments of the invention may be implemented in a variety of electronic devices and logic circuits. Furthermore, devices or circuits that include embodiments of the invention may be included within a variety of computer systems, including a point-to-point (p2p) computer system and shared bus computer systems. Embodiments of the invention may also be included in other computer system topologies and architectures.

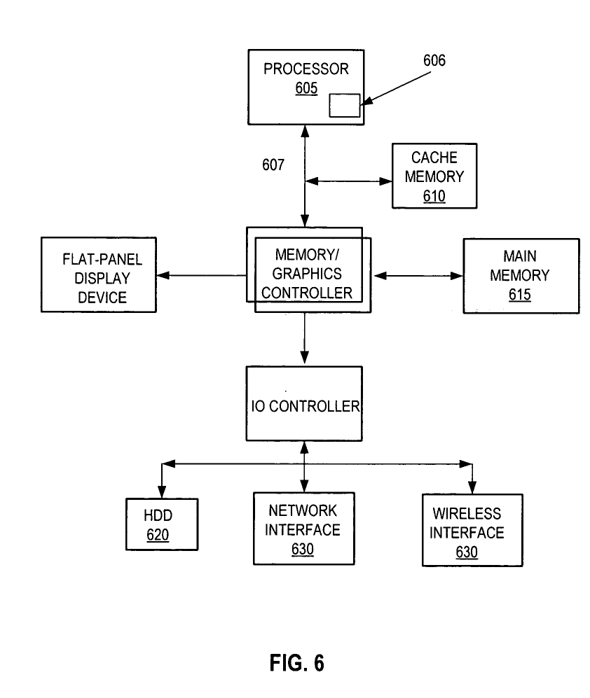

FIG. 6, for example, illustrates a front-side-bus (FSB) computer system in which one embodiment of the invention may be used. A processor 605 accesses data from a level one (L1) cache memory 610 and main memory 615. In other embodiments of the invention, the cache memory may be a level two (L2) cache or other memory within a computer system memory hierarchy. Furthermore, in some embodiments, the computer system of FIG. 6 may contain both a L1 cache and an L2 cache.

Illustrated within the processor of FIG. 6 is one embodiment of the invention 606. The processor may have any number of processing cores. Other embodiments of the invention, however, may be implemented within other devices within the system, such as a separate bus agent, or distributed throughout the system in hardware, software, or some combination thereof.

The main memory may be implemented in various memory sources, such as dynamic random-access memory (DRAM), a hard disk drive (HDD) 620, or a memory source located remotely from the computer system via network interface 630 containing various storage devices and technologies. The cache memory may be located either within the processor or in close proximity to the processor, such as on the processor's local bus 607.

Furthermore, the cache memory may contain relatively fast memory cells, such as a six-transistor (6T) cell, or other memory cell of approximately equal or faster access speed. The computer system of FIG. 6 may be a point-to-point (PtP) network of bus agents, such as microprocessors, that communicate via bus signals dedicated to each agent on the PtP network. Within, or at least associated with, each bus agent may be at least one embodiment of invention 606. Alternatively, an embodiment of the invention may be located or associated with only one of the bus agents of FIG. 6, or in fewer than all of the bus agents of FIG. 6.

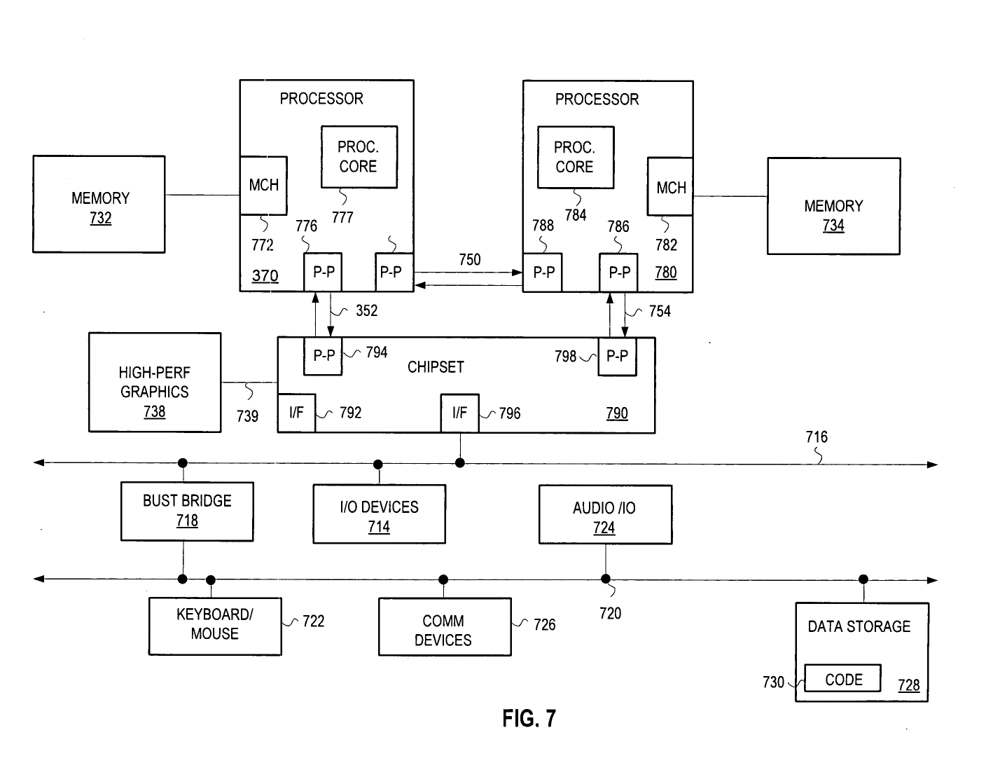

Similarly, at least one embodiment may be implemented within a point-to-point computer system. FIG. 7, for example, illustrates a computer system that is arranged in a point-to-point (PtP) configuration. In particular, FIG. 7 shows a system where processors, memory, and input/output devices are interconnected by a number of point-to-point interfaces.

The system of FIG. 7 may also include several processors, of which only two, processors 770, 780 are shown for clarity. Processors 770, 780 may each include a local memory controller hub (MCH) 772, 782 to connect with memory 732, 734. Processors 770, 780 may exchange data via a point-to-point (PtP) interface 350 using PtP interface circuits 778, 788. Processors 770, 780 may each exchange data with a chipset 790 via individual PtP interfaces 752, 754 using point to point interface circuits 776, 794, 786, 798. Chipset 790 may also exchange data with a high-performance graphics circuit 738 via a high-performance graphics interface 739. Embodiments of the invention may be located within any processor having any number of processing cores, or within each of the PtP bus agents of FIG. 7.

Other embodiments of the invention, however, may exist in other circuits, logic units, or devices within the system of FIG. 7. Furthermore, in other embodiments of the invention may be distributed throughout several circuits, logic units, or devices illustrated in FIG. 7.

Each device illustrated in FIGS. 6 and 7 may contain multiple cache agents, such as processor cores, that may access memory associated with other cache agents located within other devices within the computer system.

For the sake of illustration, an embodiment of the invention is discussed below that may be implemented in a p2p computer system, such as the one illustrated in FIG. 7. Accordingly, numerous details specific to the operation and implementation of the p2p computer system of FIG. 7 will be discussed in order to provide an adequate understanding of at least one embodiment of the invention. However, other embodiments of the invention may be used in other computer system architectures and topologies, such as the shared-bus system of FIG. 6. Therefore, reference to the p2p computer system of FIG. 7 should not be interpreted as the only computer system environment in which embodiments of the invention may be used. The principals discussed herein with regard to a specific embodiment or embodiments are broadly applicable to a variety of computer system and processing architectures and topologies.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.)), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

It is believed that processes taught by the discussion above may also be described in source level program code in various object-orientated or non-object-orientated computer programming languages (e.g., Java, C#, VB, Python, C, C++, J#, APL, Cobol, Fortran, Pascal, Perl, etc.) supported by various software development frameworks (e.g., Microsoft Corporation's .NET, Mono, Java, Oracle Corporation's Fusion, etc.). The source level program code may be converted into an intermediate form of program code (such as Java byte code, Microsoft Intermediate Language, etc.) that is understandable to an abstract execution environment (e.g., a Java Virtual Machine, a Common Language Runtime, a high-level language virtual machine, an interpreter, etc.), or a more specific form of program code that is targeted for a specific processor.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

We claim:

1. A apparatus, comprising:
a processor core;
an interface to translate requests to and from the processor core; and
a first routing component to process transactions directed to and from the processor core through the interface.

2. The apparatus of claim 1, wherein the first routing component comprises:
a routing table to store addresses associated with a packet received from the interface;
a bid buffer to store bid request information associated the packet;
an input buffer to store the packet.

3. The apparatus of claim 2, further comprising:
a cache to store data for the processor core;
a home agent to store cache requests; and
a second routing component to process transactions directed to and from the home agent.

4. The apparatus of claim 3, wherein the second routing component comprises:
a routing table to store addresses associated with a packet received from the home agent;
a bid buffer to store a bid request associated the packet; and
an input buffer to store the packet.

5. The apparatus of claim 4, further comprising:
a set of one or more queues to store the bid request, wherein each queue stores bid request information specific to a destination routing component; and
a set of one or more arbiters to process bid requests.

6. The apparatus of claim 5, wherein the set of one or more arbiters comprises:
a queue arbiter to select a bid from each of the queues and generate a set of bids;
a local arbiter to select a bid from the set of bids selected by the arbiter,
wherein the bid selected by the global arbiter is submitted to another routing component; and
a global arbiter to determine what packets to transmit from other routing components.

7. The apparatus of claim 3, wherein the first routing component further comprises:
an output queue to transmit a packet received from the second routing component.

8. The apparatus of claim 3, wherein the second routing component further comprises:
an output queue to transmit a packet received from the first routing component and other routing components.

9. A method comprising:
receiving a packet from an interface in communication with a processor core at a first routing component;
determining if a second routing component is able to process the packet; and
transmitting said packet to a second routing component from the first routing component upon determining that the second routing component is able to process the packet.

10. The method of claim 9, further comprising:
temporarily storing the packet in the first routing component.

11. The method of claim 10, wherein the determining comprises:
performing a check to see if the second component has buffer space for the packet.

12. The method of claim 9, further comprising:
receiving a packet transmission request from the second routing component;
determining if the packet transmission request will be granted;
transmitting a request granted notification to the second routing component if the request is granted; and
receiving a packet from the second routing component if the request is granted.

13. The method of claim 12, further comprising:
determining a recipient for the received packet; and
transmitting the packet to the recipient.

14. A system comprising:
a first socket comprising:
a processor core,
an interface to translate requests to and from the processor core, and
a first routing component to process transactions directed to and from the processor core through the interface;
a second socket to receive a packet sent from the first socket; and
a network to transmit requests between the first and second sockets.

15. The system of claim 14, wherein the first routing component comprises:
a routing table to store addresses associated with a packet received from the interface;
a bid buffer to store bid request information associated the packet;
an input buffer to store the packet.

16. The system of claim 15, wherein the first socket further comprises:
a cache to store data for the processor core;
a home agent to store cache requests; and
a second routing component to process transactions directed to and from the home agent.

17. The system of claim 16, wherein the second routing component comprises:
a routing table to store addresses associated with a packet received from the home agent;
a bid buffer to store a bid request associated the packet; and
an input buffer to store the packet.

18. The system of claim 16, wherein the second routing component further comprising:
a set of one or more queues to store the bid request, wherein each queue stores bid request information specific to a destination routing component; and
a set of one or more arbiters to process bid requests.

19. The system of claim 17, wherein the set of one or more arbiters comprises:
a queue arbiter to select a bid from each of the queues and generate a set of bids;
a local arbiter to select a bid from the set of bids selected by the arbiter,
wherein the bid selected by the global arbiter is submitted to another routing component; and
a global arbiter to determine what packets to transmit from other routing components.

20. The system of claim 15, wherein the first routing component further comprises:
an output queue to transmit a packet received from the second routing component.
